(19) United States
(12) Patent Application Publication
(10) Pub. No.: US 2010/0043721 A1
(43) Pub. Date: Feb. 25, 2010

(54) RETRACTABLE PET LEASH WITH INTEGRATED FEED DISH

(76) Inventor: Laurie Cigan, Chicago, IL (US)

Correspondence Address: LAW OFFICE OF MARC D. MACHTINGER, LTD., 750 W. LAKE COOK ROAD, SUITE 350, BUFFALO GROVE, IL, 60089, US

(21) Appl. No.: 12/194,773

(22) Filed: Aug. 20, 2008

(51) Int. Cl. B65H 75/34

(52) U.S. Cl. 119/796

(57) ABSTRACT

A retractable pet leash having an integral and removable food or water dish is disclosed. The retractable pet leash has a housing assembly having a handle formed therein and a container passageway formed therein. A retractable leash assembly is disposed in the housing assembly. The leash assembly has an open center section. A container assembly is disposed in the container passageway and the open center section. The container assembly has a closed end and an open end. The open end is accessible through the container passageway. A container cover is removably connected to the open end of the container assembly.

### BACKGROUND

The present invention relates to pet leashes and more specifically to retractable pet leashes. Even more specifically, the present invention relates to a retractable pet leash having an integrated and removable food or water dish.

### DESCRIPTION OF THE RELATED ART

Since the early domestication of animals as pets, the need for the pets' owners to care and feed the animals in exchange for the animals' companionship and protection has been known. Jumping forward to the present day, pet owners are still acutely aware of the needs of their pets. More than one commentator has likened caring for a pet as not dissimilar to caring for a small child, including a seemingly constant need to provide food and or drink for the pet—particularly at times when the food or drink is not conveniently available.

A common device used when walking pets is a retractable leash. An example of a retractable leash is disclosed in Published U.S. Patent Application No. 2003/0145803. As disclosed, the retractable leash has a housing containing a spring-biased reel in which the remaining length of leash can be taken up and which is stoppable by means of an actuating mechanism. A retractable leash of this kind is improved according to the invention by means of a device for adjusting the maximum extension length of the leash as required and providing for the slack section of the leash to be taken up automatically by the reel when this maximum extension length is not being used. This ensures that the leash is always taut without restricting the animal's freedom of movement unnecessarily.

The need to carry items while using a pet leash is also known. For example, Published U.S. Patent Application No. 2006/0219188 disclosed an implement for carrying waste while using a leash. The implement includes a leash receiving member for releasably securing the leash thereto. A waste receiving container is provided for receiving the waste thereinto. The container includes an attachment portion for releasably attaching the leash receiving member thereto. The container defines an upper opening for receiving the waste therethrough and a lower opening for releasing the waste therethrough. The container includes a trap for releasing the waste. The trap is operable between a closed configuration and an open configuration. In the closed configuration, the trap substantially blocks the opening. In the open configuration, the trap substantially frees the opening.

Similarly, Published U.S. Patent Application No. 2003/0037733 discloses an animal waste collection and disposal apparatus and sub-assembly for the same. As disclosed, a sub-assembly for use in association with an animal waste collection and disposal apparatus comprises a retaining member, wherein the retaining member is associable with a leash, and further wherein the retaining member is configured to retain a container for collecting and disposing animal waste; and at least one fastener, wherein the at least one fastener is capable of securing the retaining member to a leash.

The need to carry food and or water for the pet has also been recognized. For example, U.S. Pat. No. 5,823,136, issued Oct. 20, 1998, and issued to Zarski, discloses a carriable pet feeding service. According to this “Zarski” patent a carriable pet food and water service which provides sealed containers for food and water, integral dishes and easy carrying during a walk with the pet is disclosed. The carriable pet feeding service includes a hinged casing which opens into two half-sections. Each half-section is provided with an interior receptacle. Removably received in each receptacle is a reciprocably shaped container, one respectively for holding pourable dry or semi-dry food and the other respectively for holding water. At least one carrying strap is connected with the exterior surface of the casing so that the pet owner can carry the casing and its interiorly disposed food and water containers when the casing is closed. It is further preferred that the strap be serviceable as a leash, and still further preferred to include a second strap for carrying of the casing when the other strap is being used as a leash.

However many such devices, require a completely separate container system to be carried in addition to the leash. This separateness creates several obstacles. Foremost, it occupies the user's hands with the device (and the other hand is occupied by the leash). If the device is carried over the user's shoulder or in a backpack type bag, the device at least partially restricts the user's movements. Additionally, the separateness increases the possibility of components being lost or misplaced while they are being used.

Accordingly, there remains a need for a retractable pet leash having an integrated and removable food or water dish. Therefore, it would be desirable to produce a retractable pet leash having an integrated and removable food or water dish.

### SUMMARY

In view of the deficiencies described above, it is an object of the present invention to provide a retractable pet leash having an integrated and removable food or water dish.

In accordance with the above objectives, the present invention is a retractable pet leash having an integrated and removable food or water dish. The retractable pet leash has a housing assembly having a handle formed therein and a container passageway formed therein. A retractable leash assembly is disposed in the housing assembly. The retractable leash assembly has an open center section which is substantially concentric with the container passageway.

A container assembly is disposed in the container passageway and the open center section. A container cover is removably connected to container assembly. The container cover can be removably secured to the container assembly using various means known in the art.

In various preferred embodiments, the container assembly can be removed from the container passageway. Various means, known in the art, can be used to removably secure the container assembly in the container passageway.

In various preferred embodiments the housing assembly has a raised rim disposed on one side of said housing assembly. The container assembly is secured, sometimes removably so, to the raised rim. As before, a container cover is removably connected to the container assembly using means known in the art.

In other various preferred embodiments the raised rim forms a first container disposed on one side of said housing assembly. The container cover is removably connected to the raised rim using means known in the art.

In other various embodiments, the container cover may also serve as a second container.

Other features and advantages of the invention will be apparent from the following detailed description taken in conjunction with the following drawings wherein like reference numerals represent like features.

### BRIEF DESCRIPTION OF THE FIGURES

FIG. 1 shows an exploded view of a pet leash according to the present invention.

FIG. 2 shows a perspective view of a pet leash according to the present invention.

FIG. 3 shows a pet leash according to the present invention in use.

FIG. 4 shows a first embodiment of a container cover as part of a pet leash according to the present invention.

FIG. 5 shows a second embodiment of a container cover as part of a pet leash according to the present invention.

FIG. 6 shows a perspective view of an alternate embodiment of a pet leash according to the present invention.

FIG. 7 shows a perspective view of yet another alternate embodiment of a pet leash according to the present invention.

FIG. 8 shows a perspective view of still another alternate embodiment of pet leash according to the present invention.

### DETAILED DESCRIPTION OF THE INVENTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

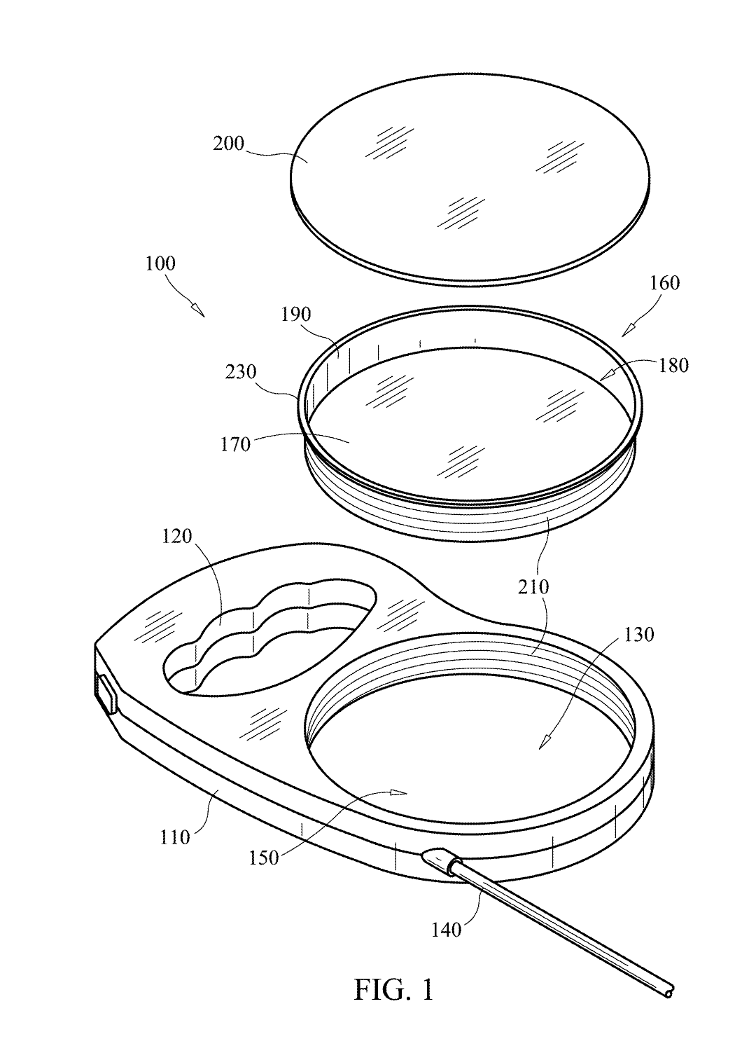

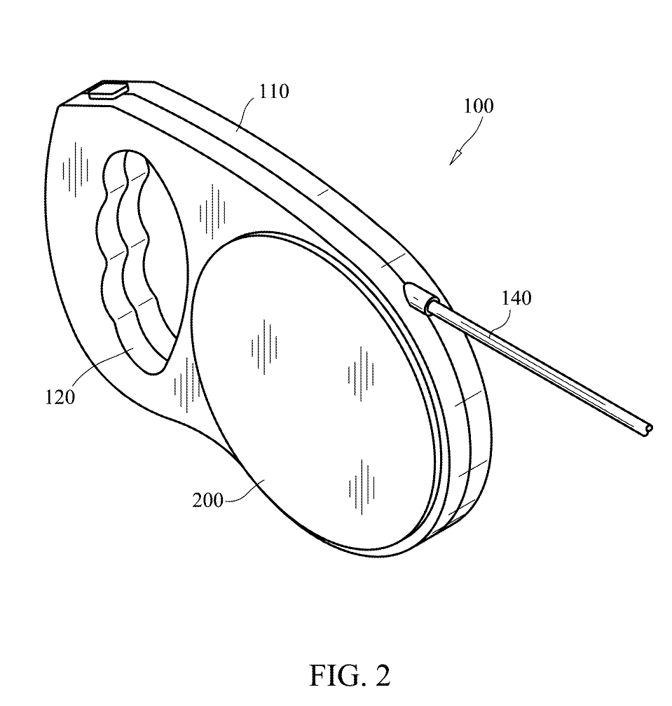

The present invention is a retractable pet leash having an integrated and removable food or water dish. FIG. 1 shows an exploded view of a pet leash according to the present invention. The retractable pet leash 100 has a housing assembly 110 having a handle 120 formed therein and a container passageway 130 formed therein. FIG. 2 shows a perspective view of a pet leash according to the present invention. A retractable leash assembly 140 is disposed in the housing assembly 110. The retractable leash assembly 140 has an open center section 150 which is substantially concentric with the container passageway 130.

A container assembly 160 is disposed in the container passageway 130 and the open center section 150. The container assembly 160 has a closed end 170, an open end 180, and a sidewall 190 which connects the closed end 170 and the open end 180. The open end 180 is accessible via the container passageway 130. A container cover 200 is removably connected to the open end 180 of the container assembly 160.

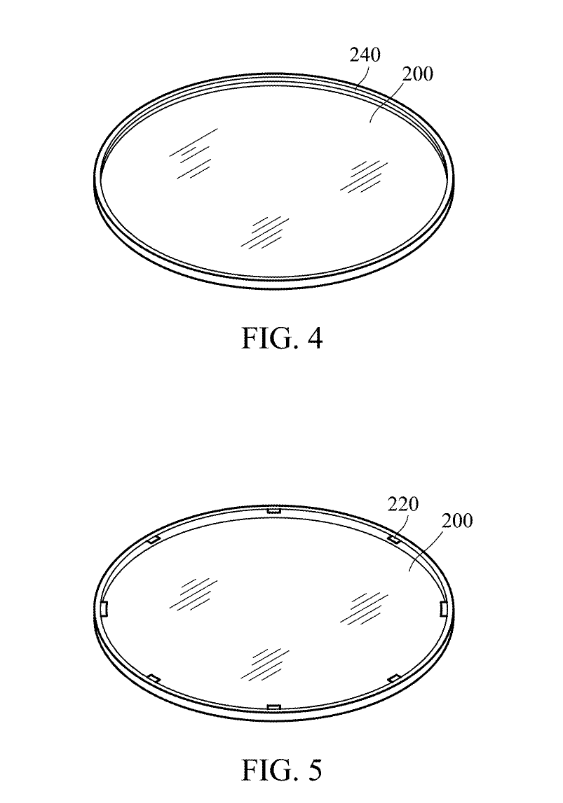

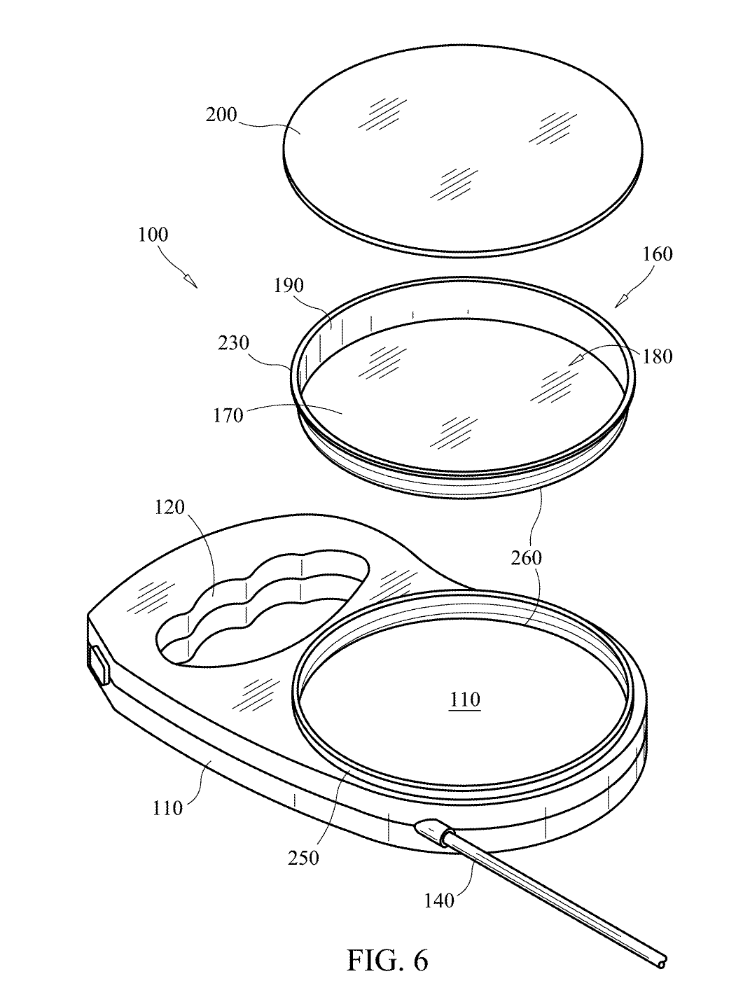

The container cover 200 can be removably secured to the container assembly 160 using various means known in the art. FIG. 4 shows a first embodiment of a container cover as part of a pet leash according to the present invention. FIG. 5 shows a second embodiment of a container cover as part of a pet leash according to the present invention. For example, and not by limitation, a set of cooperatively engaging threads 240 disposed on the container cover 200 and the container assembly 160 can be used to removably secure the container cover 200 to the container assembly 160. In another example, a set of tab members 220 disposed on the container cover 200 removably engage a ridge 230 on the container assembly 160.

In various preferred embodiments, the container assembly 160 can be removed from the container passageway 130. Various means, known in the art, can be used to removably secure the container assembly 160 in the container passageway 130. For example, and not by limitation, a set of cooperatively engaging threads 210 disposed on the container passageway 130 and 160 container assembly can be use to removably secure the container assembly 160 in the container passageway 130.

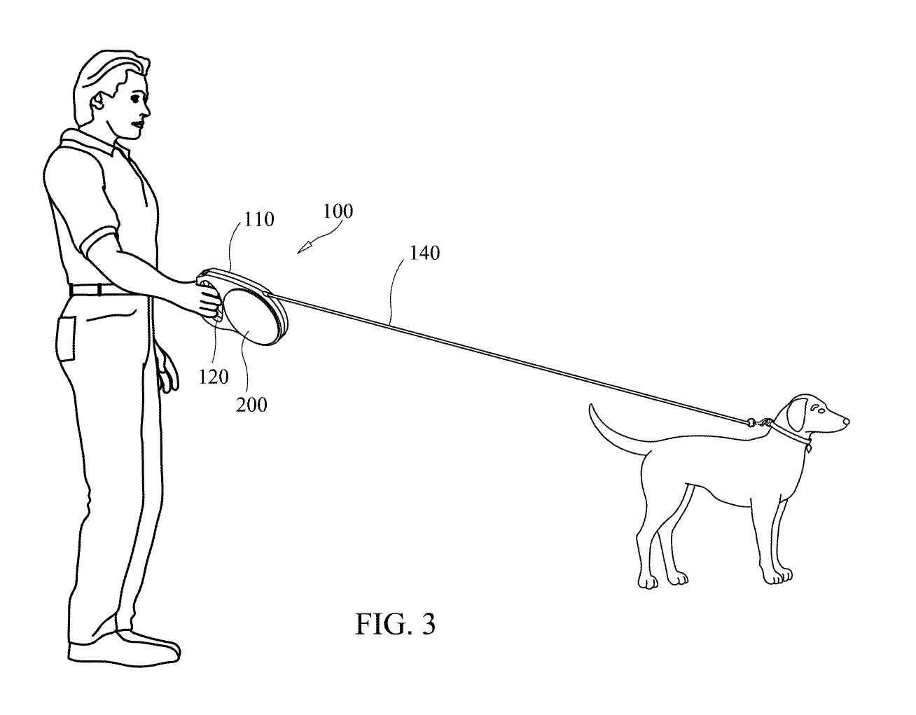

FIG. 3 shows a pet leash according to the present invention in use. In use, the user, pet owner, pet walker, or the like, can take their pet out for a walk or jog as is done with a common retractable leash. However, when the pet becomes hungry or thirsty, the user can simply open the container cover 200 and permit the pet to eat or drink from the container assembly 160. In embodiments where the container assembly 160 is removable from the housing assembly 110, the user can remove the container assembly 160 from the housing assembly 110 for the pet to feed or drink from. Removing the container assembly 160 from the housing assembly 110 also facilitates easier cleaning, storage and care of the container assembly 160.

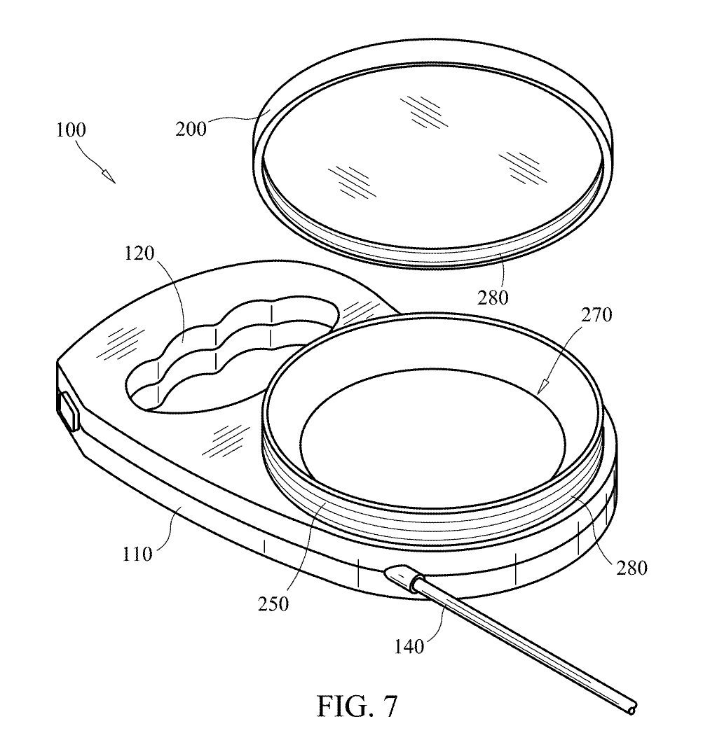

FIG. 6 shows a perspective view of an alternate embodiment of a pet leash according to the present invention. In the embodiment shown in FIG. 6, the pet leash apparatus 100 has a housing assembly 110 having a handle 120 formed in the housing assembly 110 and a retractable leash assembly 140 operatively disposed in the housing assembly 110 as previously described. However, in the embodiment shown, the housing assembly 110 has a raised rim 250 disposed on one side of said housing assembly 110. As before, a container cover 200 is removably connected to the open end 180 of the container assembly 160 using means known in the art.

The raised rim 250 has means for securing the container assembly 160 thereto. In various preferred embodiments, the container assembly 160 is removably secured to the raised rim 250. The container assembly 160 can be removably secured to the raised rim 250 using various means known in the art. For example, and not by way of limitation, a set of cooperatively engaging threads 260 can be disposed on the rim 250 and the container assembly 160.

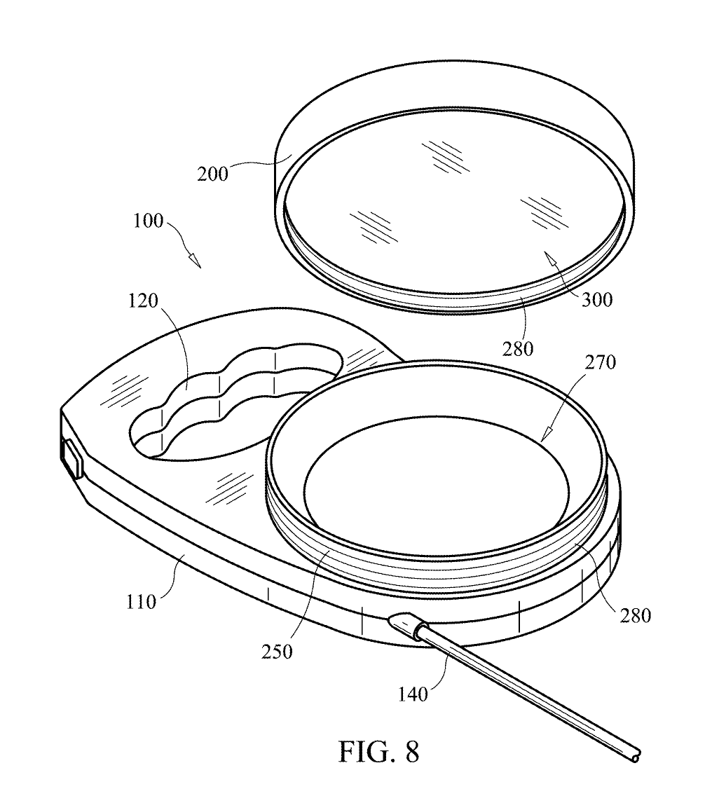

FIG. 7 shows a perspective view of yet another alternate embodiment of a pet leash according to the present invention. In the embodiment shown in FIG. 7, the pet leash apparatus 100 has a housing assembly 110 having a handle 120 formed in the housing assembly 110 and a retractable leash assembly 140 operatively disposed in the housing assembly 110 as previously described. However, in the embodiment shown, the housing assembly 110 has a raised rim 250 which forms a first container 270 disposed on one side of said housing assembly 110.

The container cover 200 is removably connected to the raised rim 250 using means known in the art. For example, and not by way of limitation, a set of cooperatively engaging threads 280 can be disposed on the rim 250 and the container cover 200. As another example, again not by limitation, a set of tab members 220 (as shown in FIG. 5) on the container cover 200 can removably engage a ridge 230 (as shown in FIG. 5) on the raised rim 250 to removably secure the container cover 200 to the raised rim 250.

FIG. 8 shows a perspective view of still another alternate embodiment of pet leash according to the present invention. In embodiments in accordance with FIG. 8, the container cover 200 may also serve as a second container 300. In these embodiments, the owner can fill the second container 300 with, for example, water when the container assembly 160 or the first container 270 is being used to hold food. Thus the apparatus 100 becomes more versatile.

While the specific embodiments have been illustrated and described, numerous modifications come to mind without significantly departing from the spirit of the invention, and the scope of protection is only limited by the scope of the accompanying claims.

What is claimed is:

1. A pet leash apparatus comprising:
a housing assembly having a handle formed therein and a container passageway formed therein,
a retractable leash assembly disposed in said housing and having an open center section, wherein said open center section is substantially concentric with said container passageway,
a container assembly disposed in said container passageway and said open center section,
said container assembly having a closed end, an open end, and a sidewall connecting said closed end and said open end, and wherein said open end is accessible via said container passageway, a container cover removably connected to said open end of said container assembly, and means for removably securing said container cover to said container assembly.

2. The pet leash apparatus according to claim 1, wherein said container assembly is removably disposed in said container passageway and said open center sections and said apparatus further comprises means for removably securing said container assembly in said container passageway.

3. The pet leash apparatus according to claim 2, wherein said means for removably securing said container assembly in said container passageway comprises a set of cooperatively engaging threads disposed on said container passageway and said container assembly.

4. The pet leash apparatus according to claim 1, wherein said means for removably securing said container cover to said container assembly comprises a set of cooperatively engaging threads disposed on said container cover and said container assembly removably secure said container cover to said container assembly.

5. The pet leash apparatus according to claim 1, wherein said means for removably securing said container cover to said container assembly comprises a set of tab members disposed on said container cover that removably engage a ridge on said container assembly.

6. The pet leash according to claim 1, wherein said container cover forms a second container.

7. A pet leash apparatus comprising:
a housing assembly having a handle formed in said housing assembly, a retractable leash assembly operatively disposed in said housing assembly,
said housing assembly further having a raised rim disposed on one side of said housing assembly, said rim having means for securing a container assembly thereto,
said container assembly having a closed end, an open end, and a sidewall connecting said closed end and said open, a container cover removably connected to said open end of said container assembly, and means for removably securing said container cover to said container assembly.

8. The pet leash apparatus according to claim 7, wherein said container assembly is removably secured to said rim and said apparatus further comprises means for removably securing said container assembly to said rim.

9. The pet leash apparatus according to claim 8, wherein said means for removably securing said container assembly to said rim comprises a set of cooperatively engaging threads disposed on said rim and said container assembly.

10. The pet leash apparatus according to claim 7, wherein said means for removably securing said container cover to said container assembly comprises a set of cooperatively engaging disposed on said container cover and said container assembly.

11. The pet leash apparatus according to claim 7, wherein said means for removably securing said container cover to said container assembly comprises a set of tab members disposed on said container cover that removably engage a ridge on said container assembly.

12. The pet leash apparatus according to claim 7, wherein said container cover forms a second container.

13. A pet leash apparatus comprising:
a housing assembly having a handle formed in said housing assembly, a retractable leash assembly operatively disposed in said housing assembly,
said housing assembly further having a raised rim disposed on one side of said housing assembly, said raised rim forming a first container,
a container cover removably connected to raised rim, and
means for removably securing said container cover to raised rim.

14. The pet leash apparatus according to claim 13, wherein said means for removably securing said container cover to raised rim comprises a set of cooperatively engaging disposed on said container cover and raised rim.

15. The pet leash apparatus according to claim 13, wherein said means for removably securing said container cover to said raised rim comprises a set of tab members disposed on said container cover that removably engage a ridge on said container assembly.

16. The pet leash apparatus according to claim 13, wherein said container cover forms a second container.
